(19) United States
(12) Patent Application Publication
(10) Pub. No.: US 2021/0223466 A1
(43) Pub. Date: Jul. 22, 2021

(54) BACKLIGHT MODULE AND DISPLAY DEVICE

(71) Applicant: WUHAN CHINA STAR OPTOELECTRONICS TECHNOLOGY CO., LTD, Wuhan, Hubei (CN)

(72) Inventor: Gege ZHOU, Wuhan, Hubei (CN)

(21) Appl. No.: 16/308,934

(22) PCT Filed: Nov. 1, 2018
(86) PCT No.: PCT/CN2018/113308

§ 371 Date: Dec. 11, 2018

(30) Foreign Application Priority Data
Jul. 26, 2018 (CN) 201810832462.8

(51) Int. Cl. F21V 8/00

(52) U.S. Cl. CPC G02B 6/0093; G02B 6/0088; G02B 6/0055

(57) ABSTRACT

A backlight module and a display device are provided. The backlight module includes a reflector, a light guide plate, and a frame disposed around the light guide plate. The backlight module further includes at least one electrically conductive film.

### BACKGROUND OF THE INVENTION

### Field of Invention

The present invention relates to a display technology, and more particularly to a backlight module and a display device using the same.

### Description of Prior Art

At present, as a display component of electronic device, a liquid crystal display device has been widely used in various electronic products. Consumers have higher and higher requirements on the use environment of the devices, which requires an improvement in the antistatic capability of the display device. Backlight module is an important component in liquid crystal display device, and its antistatic ability requirement is getting higher and higher.

Please refer to FIG. 1. FIG. 1 shows a conventional backlight module 10 of a small-size liquid crystal display. As shown in FIG. 1, the backlight module 10 includes a light guide plate 11, a frame 12 disposed around the light guide plate 11, a light source 16, a flexible circuit board 13 of the light source 16, and a shielding tape 14. An optical film 15 is fixed on the frame 12 by the shielding tape 14, and the shielding tape 14 can also be used to shield the backlight module 10.

However, since the higher requirement of antistatic ability, the backlight module as shown in FIG. 1 could not meet the requirement and has a problem on antistatic resulting in a malfunction of the equipment.

Therefore, an improvement on the backlight module structure is needed to enhance the antistatic ability of the backlight module and solve the existing technical problems.

### SUMMARY OF THE INVENTION

In view of the above, the present invention provides a backlight module with an electrically conductive film to improve the antistatic ability of the backlight module and a display device.

In order to achieve the above-mentioned object of the present invention, one embodiment of the present invention provides a backlight module including a reflector, a light guide plate disposed on the reflector and contacting with the reflector, a light source assembly disposed at one side of the light guide plate, an optical film assembly disposed on the light guide plate, and a frame disposed around the light guide plate. The backlight module further includes at least one electrically conductive film, and the at least one electrically conductive film is disposed at one of the positions that (1) the at least one electrically conductive film is attached to one surface of the reflector and another surface of the reflector contacts with the light guide plate; (2) the at least one electrically conductive film is disposed between the frame and the reflector; or (3) the at least one electrically conductive film is disposed on the optical film assembly and extended to touch the frame.

one embodiment of the present invention provides a backlight module including a reflector, a light guide plate disposed on the reflector and contacting with the reflector, a light source assembly disposed at one side of the light guide plate, and a frame disposed around the light guide plate, wherein the backlight module further includes at least one electrically conductive film.

The reflector is disposed on the frame. The light beams from the light source assembly enter one side surface of the light guide plate, diffuse by the bottom surface of the light guide plate and emit from the top surface of the light guide plate to form an uniform plane light source. The reflector is disposed under the light guide plate and attached the bottom surface of the light guide plate. The reflector is capable of reflecting the light beams leaking from the bottom of the light guide plate back to the light guide plate.

In one embodiment of the present invention, the at least one electrically conductive film is attached to one surface of the reflector and another surface of the reflector contacts with the light guide plate.

In one embodiment of the present invention, the at least one electrically conductive film is disposed between the frame and the reflector.

In one embodiment of the present invention, the reflector is adhered to the frame by an electrically conductive adhesive, and the electrically conductive adhesive forms the at least one electrically conductive film.

In one embodiment of the present invention, the backlight module further includes an optical film assembly contacting with the light guide plate.

In one embodiment of the present invention, the at least one electrically conductive film is disposed on the optical film assembly and extended to touch the frame.

In one embodiment of the present invention, the at least one electrically conductive film is a shading layer disposed on the optical film assembly and extended to touch the frame.

In one embodiment of the present invention, the at least one electrically conductive film is composed of electrically conductive adhesive.

One embodiment of the present invention provides a display device including any one of the aforementioned backlight modules.

Ordinary skilled in the art can understand that the backlight module of the present invention further comprising other components that a normal backlight module should possessed, and the option of these normal components should not influence the antistatic ability of the backlight module and the display device of the present invention.

In comparison with the prior art, the backlight module and the display device accordingly to the embodiment of the present invention enhance the antistatic ability by disposing an electrically conductive film under the reflector or replacing the adhesive in the backlight module with an electrically conductive adhesive.

### BRIEF DESCRIPTION OF THE DRAWINGS

FIG. 1 is a schematic view of a structure of a prior art backlight module.

FIG. 2 is a schematic view of a structure of a backlight module according to an embodiment of the present invention.

FIG. 3 is a schematic view of a structure of a backlight module according to another embodiment of the present invention.

FIG. 4 is a schematic view of a structure of a backlight module according to still another embodiment of the present invention.

FIG. 5 is a schematic view of a structure of a display device according to an embodiment of the present invention.

### DETAILED DESCRIPTION OF THE PREFERRED EMBODIMENTS

The following description of the embodiments is provided by reference to the following drawings and illustrates the specific embodiments of the present invention. Directional terms mentioned in the present invention, such as “up,” “down,” “top,” “bottom,” “forward,” “backward,” “left,” “right,” “inside,” “outside,” “side,” “peripheral,” “central,” “horizontal,” “peripheral,” “vertical,” “longitudinal,” “axial,” “radial,” “uppermost” or “lowermost,” etc., are merely indicated the direction of the drawings. Therefore, the directional terms are used for illustrating and understanding of the application rather than limiting thereof.

### Embodiment 1: Backlight Module

Please refer to FIG. 2. An embodiment of the present invention provides a backlight module 200. The backlight module 200 includes a reflector 210, a light guide plate 220, and a frame 230 disposed around the light guide plate 220. Ordinary skilled in the art can realize that the backlight module 200 has some parts which are commonly used in the conventional backlight module.

The backlight module 200 of the embodiment is described in detail below with reference to FIG. 2.

The backlight module 200 includes the reflector 210, the light guide plate 220 disposed on the reflector 210, an optical film assembly 240 disposed on the light guide plate 220, and the frame 230. The frame 230 includes a base 231 and a side plate 232. As shown in FIG. 2, there is an accommodating space defined by the frame 230 to receive a light source 250 and a circuit board 251 connecting with the light source 250. The light source 250 is a common component in the art to provide light beams for a display panel, for example, light emitting diodes (LEDs). But the invention is not limited to this.

The backlight module 200 further includes at least one electrically conductive film 260, and the at least one electrically conductive film 260 is disposed between the base 231 of the frame 230 and the reflector 210, and is attached to one surface of the reflector 210.

Ordinary skilled in the art can realize that the backlight module 200 as shown in FIG. 2 further includes a shading layer 270. The shading layer 270 is disposed on the optical film assembly 240 to prevent the light beams from leaking from the backlight module 200 and to bind the backlight module 200 and a display panel together to form a display device, wherein the display panel will be disclosed in detail later.

It can be understood by those ordinary skilled in the art that the backlight module 200 further includes an adhesive for securing. For example, but not limited to, a first adhesive 281 is used for fixing the frame 230 and the reflector 210 together, as shown in FIG. 2 in this embodiment. The first adhesive 281 is disposed between the side plate 232 of the frame 230 and the reflector 210. The backlight module 200 further includes a second adhesive 282 for fixing the circuit board 251, the frame 230, and the light guide plate 220 together. The first adhesive 281 and the second adhesive 282 can be, for example, a double-sided tape.

### Embodiment 2: Backlight Module

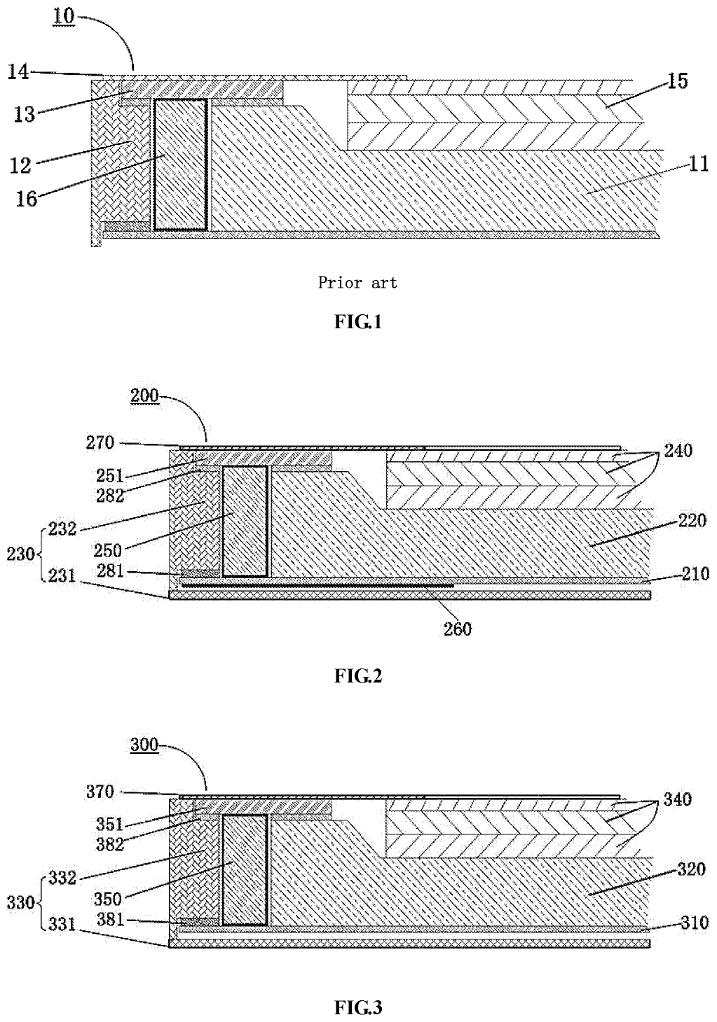

Please refer to FIG. 3. Another embodiment of the present invention provides a backlight module 300. The backlight module 300 includes a reflector 310, a light guide plate 320, and a frame 330 disposed around the light guide plate 320. Ordinary skilled in the art can realize that the backlight module 300 has some parts which are commonly used in the conventional backlight module.

The backlight module 300 of the embodiment is described in detail below with reference to FIG. 3. The backlight module 300 is similar to the backlight module 200 of the embodiment 1.

The backlight module 300 includes the reflector 310, the light guide plate 320 disposed on the reflector 310, an optical film assembly 340 disposed on the light guide plate 320, and the frame 330. The frame 330 includes a base 331 and a side plate 332. As shown in FIG. 3, there is an accommodating space defined by the frame 330 to receive a light source 350 and a circuit board 351 connecting with the light source 350. The light source 350 is a common component in the art to provide light beams for a display panel, for example, light emitting diodes (LEDs). But the invention is not limited to this.

The backlight module 300 as shown in FIG. 3 further includes a shading layer 370. The shading layer 370 is disposed on the optical film assembly 340 to prevent the light beams from leaking from the backlight module 300 and to bind the backlight module 300 and a display panel together to form a display device, wherein the display panel will be disclosed in detail later.

The shading layer 370 of this embodiment can be composed of any suitable electrically conductive material that the shading layer 370 behaved as an electrically conductive film. In other words, the shading layer 370 composed of electrically conductive material in this embodiment has the same function as the electrically conductive film 260 in embodiment 1.

It can be understood by those ordinary skilled in the art that the backlight module 300 further includes an adhesive for securing. For example, but not limited to, a first adhesive 381 is used for fixing the frame 330 and the reflector 310 together as shown in FIG. 3 in this embodiment. The first adhesive 381 is disposed between the side plate 332 of the frame 330 and the reflector 310. The backlight module 300 further includes a second adhesive 382 for fixing the circuit board 351, the frame 330, and the light guide plate 320 together. The first adhesive 381 and the second adhesive 382 can be, for example, a double-sided tape.

### Embodiment 3: Backlight Module

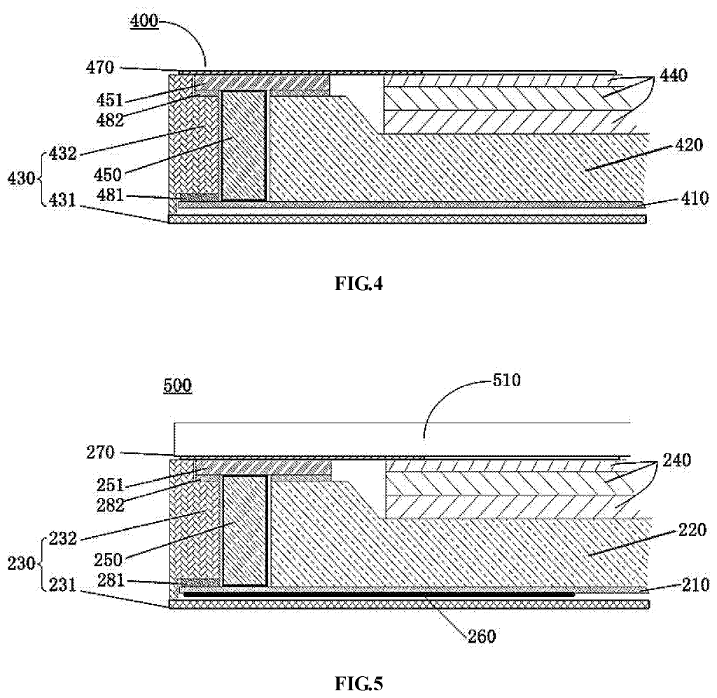

Please refer to FIG. 4. Still another embodiment of the present invention provides a backlight module 400. The backlight module 400 includes a reflector 410, a light guide plate 420, and a frame 430 disposed around the light guide plate 420. Ordinary skilled in the art can realize that the backlight module 400 has some parts which are commonly used in the conventional backlight module.

The backlight module 400 of the embodiment is described in detail below with reference to FIG. 4. The backlight module 400 is similar to the backlight module 200 of the embodiment 1.

The backlight module 400 includes the reflector 410, the light guide plate 420 disposed on the reflector 410, an optical film assembly 440 disposed on the light guide plate 420, and the frame 430. The frame 430 includes a base 431 and a side plate 432. As shown in FIG. 4, there is an accommodating space defined by the frame 430 to receive a light source 450 and a circuit board 451 connecting with the light source 450. The light source 450 is a common component in the art to provide light beams for display panel, for example, light emitting diodes (LEDs). But the invention is not limited to this.

The backlight module 400 as shown in FIG. 4 further includes a shading layer 470. The shading layer 470 is disposed on the optical film assembly 440 to prevent the light beams from leaking from the backlight module 400 and to bind the backlight module 400 and a display panel together to form a display device, wherein the display panel will be disclosed in detail later.

The backlight module 400 further includes an adhesive for securing. For example, but not limited to, a first adhesive 481 is used for fixing the frame 430 and the reflector 410 together, as shown in FIG. 4. In this embodiment, the first adhesive 481 is disposed between the side plate 432 of the frame 430 and the reflector 410. The first adhesive 481 can be composed of any suitable electrically conductive material that the first adhesive 481 behaved as an electrically conductive film. On the other words, the first adhesive 481 composed of electrically conductive material in this embodiment has the same function of the electrically conductive film 260 in embodiment 1.

As shown in FIG. 4, the backlight module 400 further includes a second adhesive 482 for fixing the circuit board 451, the frame 430, and the light guide plate 420. The second adhesive 482 can be, for example, a double-sided tape.

### Embodiment 4: Display Device

A further embodiment of the present invention provides a display device 500 including the backlight module 200 of the first embodiment and a display panel 510 attached to the backlight module 200. The display panel 510 and the backlight module 200 are attached to each other by the shading layer 270.

Ordinary skilled in the art can understand that the backlight module 300 of embodiment 2 or backlight module 400 of embodiment 3 can be attached to the display panel 510 to form a display device, too. Even when the shading layer 370 of the backlight module 300 as shown in FIG. 3 is composed of electrically conductive material, the backlight module can be attached to the display panel.

The electrically conductive adhesive can be a material with electrical conductivity and adhesion at the same time in this art, for example, glue with electrically conductive particles or electrically conductive water-based gel.

The present invention has been described by the above embodiments, but the embodiments are merely examples for implementing the present invention. It must be noted that the embodiments do not limit the scope of the invention. In contrast, modifications and equivalent arrangements are intended to be included within the scope of the invention.

1. A backlight module, comprising:
a reflector;
a light guide plate disposed on the reflector and contacting with the reflector;
a light source assembly disposed at one side of the light guide plate;
an optical film assembly disposed on the light guide plate; and
a frame disposed around the light guide plate, wherein the backlight module further comprises at least one electrically conductive film, and the at least one electrically conductive film is disposed at one of the positions that:
the at least one electrically conductive film is attached to one surface of the reflector and another surface of the reflector contacts with the light guide plate;
the at least one electrically conductive film is disposed between the frame and the reflector; or
the at least one electrically conductive film is disposed on the optical film assembly and extended to touch the frame.

2. The backlight module according to claim 1, wherein the at least one electrically conductive film is composed of electrically conductive adhesive.

3. A backlight module, comprising:
a reflector;
a light guide plate disposed on the reflector and contacting with the reflector;
a light source assembly disposed at one side of the light guide plate; and
a frame disposed around the light guide plate, wherein the backlight module further comprises at least one electrically conductive film.

4. The backlight module according to claim 3, wherein the at least one electrically conductive film is attached to one surface of the reflector and another surface of the reflector contacts with the light guide plate.

5. The backlight module according to claim 3, wherein the at least one electrically conductive film is disposed between the frame and the reflector.

6. The backlight module according to claim 5, wherein the reflector is adhered to the frame by an electrically conductive adhesive, and the electrically conductive adhesive forms the at least one electrically conductive film.

7. The backlight module according to claim 3, further comprising an optical film assembly contacting with the light guide plate.

8. The backlight module according to claim 7, wherein the at least one electrically conductive film is disposed on the optical film assembly and extended to touch the frame.

9. The backlight module according to claim 8, wherein the at least one electrically conductive film is a shading layer disposed on the optical film assembly and extended to touch the frame.

10. The backlight module according to claim 3, wherein the at least one electrically conductive film is composed of electrically conductive adhesive.

11. A display device, comprising the backlight module according to claim 3.

12. The display device according to claim 11, wherein the electrically conductive film is attached to one surface of the reflector and another surface of the reflector contacts with the light guide plate.

13. The display device according to claim 11, wherein the at least one electrically conductive film is disposed between the frame and the reflector.

14. The display device according to claim 13, wherein the reflector is adhered to the frame by an electrically conductive adhesive, and the electrically conductive adhesive forms the at least one electrically conductive film.

15. The display device according to claim 11, wherein the backlight module further comprises an optical film assembly contacting with the light guide plate.

16. The display device according to claim 15, wherein the at least one electrically conductive film is disposed on the optical film assembly and extended to touch the frame.

17. The display device according to claim 16, wherein the at least one electrically conductive film is a shading layer disposed on the optical film assembly and extended to touch the frame.
